(19) United States
(12) Patent Application Publication
(10) Pub. No.: US 2013/0292934 A1
(43) Pub. Date: Nov. 7, 2013

(54) Security Sticker

(71) Applicant: Richard Newman, Hertfordshire (GB)

(72) Inventor: Richard Newman, Hertfordshire (GB)

(73) Assignee: MAXGEAR EUROPE LIMITED, Hertfordshire (GB)

(21) Appl. No.: 13/992,889

(22) PCT Filed: Dec. 9, 2011
(86) PCT No.: PCT/GB2011/001708

§ 371 Date: Jul. 16, 2013

(30) Foreign Application Priority Data
Dec. 10, 2010 (GB) 1020947.6
May 6, 2011 (GB) 1107520.7

(51) Int. Cl. B42D 15/00

(52) U.S. Cl. CPC B42D 15/00
USPC 283/101

(57) ABSTRACT

A security sticker for three-dimensional packaging which may carry a security tag, a section of which is t-shaped such that the sticker, in use, extends across two axes of the packaging.

### FIELD OF THE INVENTION

The present invention relates to a security sticker. More especially, the invention relates to a sticker that carries a security tag and that is shaped and dimensioned to entirely seal the packaging to which it is applied.

### BACKGROUND TO THE INVENTION

The majority of packaging on retail shelving carry security tags, for example AM or RF security tags, to prevent the item (in its packaging) from being removed from the retail premises without payment.

The security tags may be embedded into the packaging. Alternatively, tags may be applied to simple stickers that are applied to the packaging.

Although such security measures deter many would-be-thieves an increasingly common problem is theft of the item by removal of the product from the packaging within the premises.

Even if the sticker is applied across the lid of the packaging (if the packaging were a box for example) the packaging can still be easily opened by squeezing the sides of the packaging to form an opening through which the product can be accessed.

The present invention seeks to alleviate the aforementioned problems with current security tags and stickers by providing a sticker for three-dimensional packaging carrying a security tag, a section of which is t-shaped such that the sticker, in use, extends across two axes of the packaging.

### STATEMENT OF INVENTION

According to one aspect of the invention, there is provided a security sticker for packaging, the sticker having at least one t-shaped section such that, in use, the sticker extends across perpendicular axes of the packaging.

Preferably, the sticker carries a security tag.

Preferably the sticker, in use, extends across perpendicular axes of the packaging at both ends so to cover all entry points of the packaging.

The section may be cruciform-shaped.

Preferably the sticker has a main elongate section and at least one laterally extending tab. Preferably there are two opposing laterally extending tags.

Preferably each end of the main section of the sticker has two tags extending opposing each other and extending outwardly from sides of the main section.

### BRIEF DESCRIPTION OF THE DRAWINGS

An embodiment of the invention will now be described, by way of example only, with reference to the accompanying FIGURE which illustrates security sticker constructed in accordance with the invention.

### DETAILED DESCRIPTION OF PREFERRED EMBODIMENTS

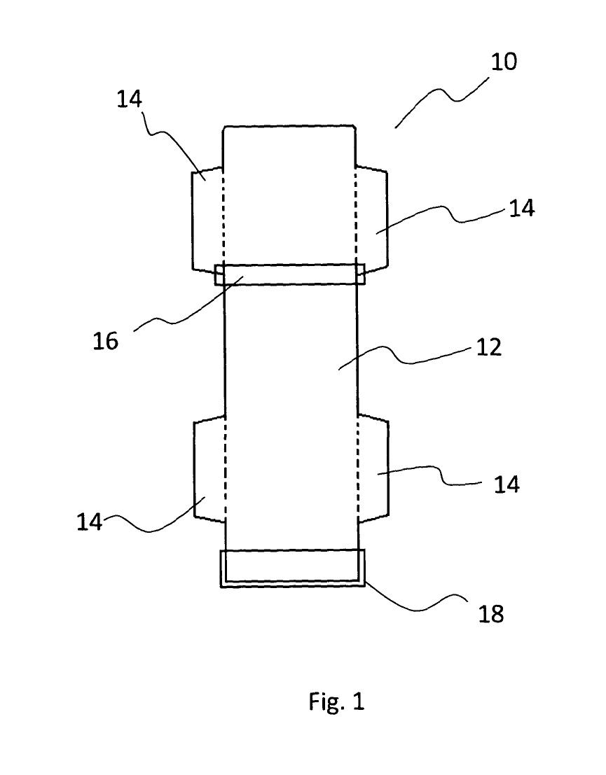

FIG. 1 illustrates a sticker 10 which has a main elongate section 12 and laterally tabs 14 extending from both sides of the sticker near to each end of the main section.

The tabs 14 form two t-shaped or cruciform sections of the sticker 10.

Each tab 14 is foldable with respect to the main section 12.

The sticker 10 carries a security tag 16, such as for example, but without limitation, an AM or RF security tag at one end. In the embodiment the security tag 16 is shown at one end of the main section 12, however it will be appreciated that the tag 16 could be located at any convenient location on the sticker 10.

A further label 18 is also carried on the sticker 10 which states that the product is security protected. Again, the label 18 could be placed in any convenient location. In some circumstances the label 18 may not be required.

The sticker 10 comprises a top coated, transparent, high gloss, biaxially orientated polypropylene film, laminated with a permanent acrylic adhesive to a glassine liner.

A suitable sticker is one supplied by Smith & McLaurin Ltd under the product name PPTC Gloss Clear 60/HT236/65WG.

PPTC Gloss Clear 60 film is particularly suited for applications where resistance to water, oil and most household detergents is important. This film is suitable for labelling rigid and semi-squeeze toiletry and cosmetic containers.

HT236 adhesive is a tackified acrylic water based adhesive designed to give high tack and adhesion to both polar and non-polar substrates. The adhesive should be used when labelling difficult substrates like polyethylene and carton board. The components of HT236 conform to FDA Indirect Food Contact 175.105.

65WG liner is a 62 gram white glassline liner suitable for use where there is automatic label registration or dispensing.

Graphic printing may be applied to the sticker 10 by a wide variety of techniques, including letterpress, flexographic, screen or litho process. The sticker 10 is also suitable for Thermal Transfer printing with many printer/ribbon combinations.

In use, a sticker 10 is applied to packaging using an applicator (for example a HERMA 400 Fix™ applicator).

The sticker 10 is applied to the packaging such that the sticker 10 extends across perpendicular axes of the packaging at both ends so to cover all areas where the container may be otherwise opened. As such, the product is entirely sealed within the packaging.

It will be appreciated that the dimensions of the sticker 10 will be variable depending on the size of the packaging to which the sticker 10 is to be applied. The tabs 14 may for example, be elongated to form arms that, in use, extend further around the corner crease container.

In an alternative embodiment (not shown) the ends of the main section may be L-shaped. In other words, the ends of the main section have only arm extending laterally from one side of the container. The arm would be of sufficient length to extend all around the container towards the other side of the main section.

A sticker 10 described above provides tamper protection protecting the label from interference. The sticker 10 has been designed with aesthetic appearance so not to compromise the item packaging while providing visual deterrent.

The tag 16 is easily deactivated at the point of sale.

In a further alternative embodiment (not shown in the figures) the sticker does not carry the security tag. Rather the security tag is located on the packaging itself. The label may also be located on the packaging.

In such an embodiment the sticker retains the same shape and form as previously described and, in use, preferably overlies the security tag and/or label to protect it from being removed or otherwise tampered with. The sticker would also maintain its primary function of sealing the packaging by extending across perpendicular axes of the packaging at both ends in such a way as to prevent the packaging from being tampered with prior to purchase.

It will be appreciated that the foregoing are merely an examples of embodiments and some examples of their use. The skilled reader will readily understand that modifications can be made thereto without departing from the true scope of the inventions.

1. A security sticker for securing three-dimensional packaging, the sticker having at least one t-shaped section such that, in use, the sticker extends across perpendicular axes of the packaging.

2. The security sticker according to claim 1, wherein the sticker carries a security tag.

3. The security sticker according to claim 1, wherein the sticker is transparent.

4. The security sticker according to claim 1, wherein the sticker is formed from a orientated polypropylene film, laminated with a permanent acrylic adhesive to a glassine liner.

5. The security sticker according to claim 1, wherein in use, extends across perpendicular axes of the packaging at both ends so to cover all entry points of the packaging.

6. The security sticker according to claim 1, wherein the sticker comprises a main elongate section and at least one laterally extending tab.

7. The security sticker according to claim 6, comprising two opposing laterally extending tags.

8. The security sticker according to claim 7, wherein each end of the main section of the sticker has two tags extending opposing each other and extending outwardly from sides of the main section.

9. Use of a security sticker according to claim 1 for sealing three-dimensional packaging whereby the sticker extends over at least two perpendicular axis of said packaging.

10. (canceled)
